(19) United States
(12) Patent Application Publication
(10) Pub. No.: US 2017/0010048 A1
(43) Pub. Date: Jan. 12, 2017

(54) THIN VAPOR CHAMBER AND MANUFACTURING METHOD THEREOF

(71) Applicant: CHAUN-CHOUNG TECHNOLOGY CORP., NEW TAIPEI CITY (TW)

(72) Inventors: SHIH-MING WANG, NEW TAIPEI CITY (TW); Pang-Hung LIAO, NEW TAIPEI CITY (TW); Cheng-Tu WANG, NEW TAIPEI CITY (TW)

(21) Appl. No.: 14/795,665

(22) Filed: Jul. 9, 2015

(51) Int. Cl. F28D 15/02; B23P 15/26

(52) U.S. Cl. CPC F28D 15/0233; B23P 15/26; B23P 2700/09

(57) ABSTRACT

A thin vapor chamber includes a heat conducting plate having an upper surface, a metal cover sealed and covering on the heat conducting plate, and a wick structure disposed between the heat conducting plate and the metal cover. A plurality of hollow supports are formed on the metal cover by pressing and face the heat conducting plate. The wick structure is provided with plural throughholes. The hollow supports are individually disposed through the corresponding throughholes and attached to the upper surface. Thus, the heat of the heat conducting plate is transferred to the metal cover through the hollow supports. Besides, the metal cover is pressed to have an uneven shape to increase heat-dissipating area and structural strength, which achieves excellent heat transfer efficiency and heat diffusion of the thin vapor chamber.

### BACKGROUND OF THE INVENTION

Field of the Invention

The present invention relates to a vapor chamber and in particular to a thin vapor chamber and a manufacturing method thereof.

Description of Prior Art

The function and working principle of the vapor chamber are similar to those of the heat pipe. The working principle uses a fluid enclosed in a plate chamber to perform a cyclical process of vaporization and condensation in which the heat caused by the heat-generating device can be rapidly and evenly absorbed by the vapor chamber and thus the vapor chamber can have the effects of fast heat transfer and heat diffusion.

However, with the shrinking dimension and weight of modern electronic products, the vapor chamber is also required to be compact and lightweight accordingly. When the internal space of the vapor chamber is shrunk, the paths for vaporization and condensation of the working fluid are decreased, which worsens the heat transfer and heat diffusion of the vapor chamber.

In view of this, the inventor pays special attention to research with the application of related theory and tries to overcome the above disadvantages, which is the research and development goal of the inventor.

### SUMMARY OF THE INVENTION

An objective of the present invention is to provide a thin vapor chamber and a manufacturing method thereof, which uses a metal cover to form a plurality of hollow supports by pressing toward a heat conducting plate. The hollow supports are individually disposed through the corresponding throughholes and attached to an upper surface of the heat conducting plate such that the heat of the heat conducting plate can be transferred to the metal cover through the hollow supports. Besides, the metal cover is pressed to have an uneven shape to increase heat-dissipating area and structural strength to achieve excellent heat transfer efficiency and heat diffusion of the thin vapor chamber of the present invention.

In order to achieve the above objective, the present invention provides a thin vapor chamber comprising a heat conducting plate, a metal cover, and a wick structure. The heat conducting plate has an upper surface. The metal cover is sealed on and covers the heat conducting plate. A plurality of hollow supports are formed on the metal cover by pressing and face the heat conducting plate. The wick structure is disposed between the heat conducting plate and the metal cover. The wick structure is provided with a plurality of throughholes. The hollow supports are individually disposed through the corresponding throughholes and attached to the upper surface.

In order to achieve the above objective, the present invention also provides a manufacturing method of the thin vapor chamber, which comprises the steps of: (a) providing a heat conducting plate and a wick structure in which the heat conducting plate has an upper surface and the wick structure is provided with a plurality of throughholes in which the wick structure is disposed on the upper surface; (b) providing a metal cover and forming a plurality of hollow supports on the metal cover by pressing; (c) covering the heat conducting plate with the metal cover such that the hollow supports are individually disposed through the corresponding throughholes and attached to the upper surface; (d) sealing and bonding the heat conducting plate and an edge of the metal cover such that a closed space is formed between the heat conducting plate and the metal cover; and (e) providing a working fluid to be filled in the closed space and pumping down and sealing the closed space.

### BRIEF DESCRIPTION OF DRAWING

FIG. 1 is a perspective exploded view of a thin vapor chamber of the present invention;

FIG. 2 is a perspective assembled view of a thin vapor chamber of the present invention;

FIG. 3 is a cross-sectional schematic view of a thin vapor chamber of the present invention;

FIG. 4 is a schematic view showing the hollow supports disposed through the throughholes and attached to the upper surface;

FIG. 5 is a perspective exploded view of a thin vapor chamber according to another embodiment of the present invention; and

FIG. 6 is a flowchart of a manufacturing method of a thin vapor chamber of the present invention.

### DETAILED DESCRIPTION OF THE INVENTION

The detailed description and technical details of the present invention will be explained below with reference to accompanying figures. However, the accompanying figures are only for reference and explanation, but not to limit the scope of the present invention.

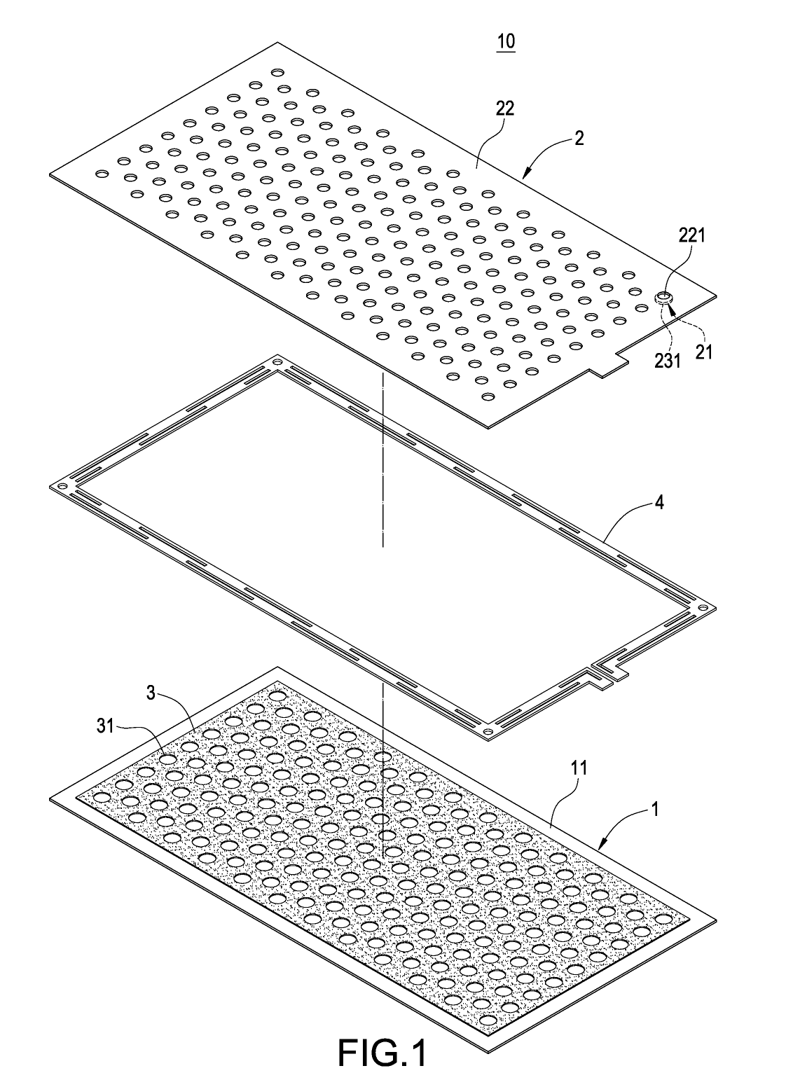

Please refer to FIGS. 1-6. The present invention provides a thin vapor chamber and a manufacturing method thereof. The thin vapor chamber 10 comprises a heat conducting plate 1, a metal cover 2, and a wick structure 3.

As shown in FIGS. 1-4, the heat conducting plate 1 is made of metal material with high heat conductivity such as sliver, copper, aluminum, or steel. The heat conducting plate 1 has an upper surface 11 and a lower surface 12 which are opposite to each other.

As shown in FIGS. 1-5, the metal cover 2 is sealed on and covers the heat conducting plate 1. A plurality of hollow supports 21 are formed on the metal cover 2 by pressing and face the heat conducting plate 1. The detailed description is given below. The metal cover 2 has a topside 22 and a bottom side 23. The hollow supports 21 individually form corresponding recesses 221 facing the topside 22 and form corresponding protrusions 231 facing the bottom side 23 such that a cross section of the metal cover 2 has a zigzag shape. The metal cover 2 is made of metal material with high heat conductivity such as sliver, copper, aluminum, or steel.

As shown in FIGS. 1-5, the wick structure 3 is disposed between the heat conducting plate 1 and the metal cover 2, and disposed on the upper surface 11. The wick structure 3 is provided with a plurality of throughholes 31. The hollow supports 21 are individually disposed through the corresponding throughholes 31 and attached to the upper surface 11.

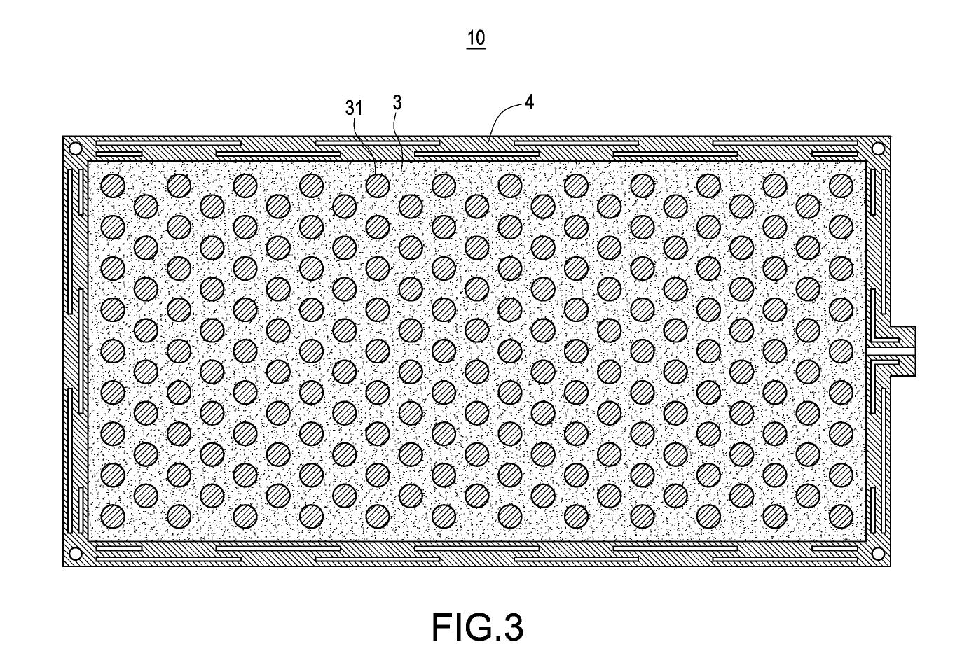

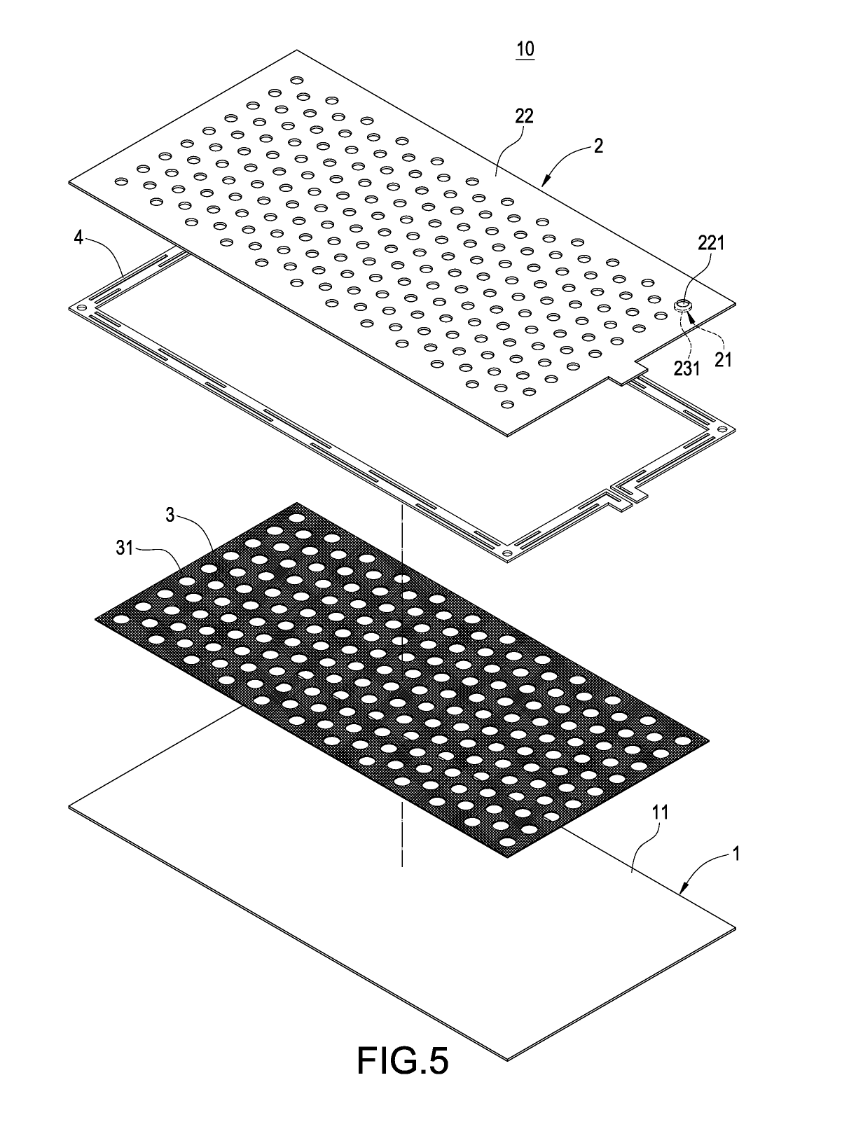

The wick structure 3 in FIG. 3 is made of sintered particles. FIG. 5 is another embodiment of the thin vapor chamber 10 of the present invention. The embodiment in FIG. 5 is roughly similar to that in FIG. 1. The difference between these two embodiments is that the wick structure 3 in FIG. 5 is made of metal mesh, but not limited to this. For example, the wick structure 3 can be made of sintered particles, metal mesh, etched grooves or the combination thereof.

As shown in FIGS. 1-5, the thin vapor chamber 10 further comprises a working fluid and a bonding frame 4. A closed space s is formed by the heat conducting plate 1 and an inner part of the metal cover 2. The working fluid is filled in the closed space s. The bonding frame 4 is bonded between the heat conducting plate 1 and the metal cover 2.

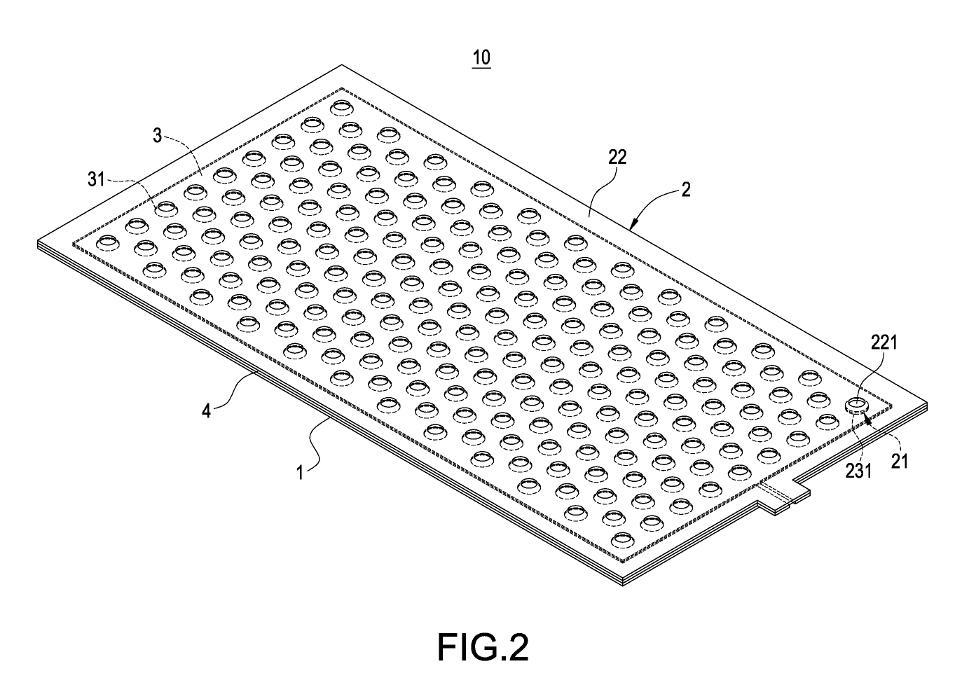

As shown in FIGS. 2-4, the assembly of the thin vapor chamber 10 of the present invention is described. The heat conducting plate 1 has the upper surface 11. The metal cover 2 is sealed on and covers the heat conducting plate 1 in which a plurality of hollow supports 21 are formed on the metal cover 2 by pressing and face the heat conducting plate 1. The wick structure 3 is disposed between the heat conducting plate 1 and the metal cover 2 in which the wick structure 3 is provided with a plurality of throughholes 31. The hollow supports 21 are individually disposed through the corresponding throughholes 31 and attached to the upper surface 11. Thus, the heat of the heat conducting plate 1 can be transferred to the metal cover 2 through the hollow supports 31. Besides, the metal cover 2 is pressed to have an uneven shape to increase heat-dissipating area and structural strength, which achieves excellent heat transfer efficiency and heat diffusion of the thin vapor chamber of the present invention.

FIGS. 2-4 indicate an operating state of the thin vapor chamber 10 of the present invention. When the lower surface 12 of the heat conducting plate 1 is attached to the heat-generating device, because the hollow supports 21 are individually disposed through the corresponding throughholes 31 and attached to the upper surface 11, the heat of the heat-generating device is transferred from the hollow supports 21 directly to the metal cover 2 through the upper surface 11. Besides, the metal cover 2 is pressed to have an uneven shape to increase heat-dissipating area and thus the heat of the metal cover 2 is further rapidly dissipated to the external environment, which solves the problem of insufficient paths for internal vaporization and condensation of the heat conducting plate 1 to make the thin vapor chamber 10 of the present invention have excellent heat transfer efficiency and heat diffusion.

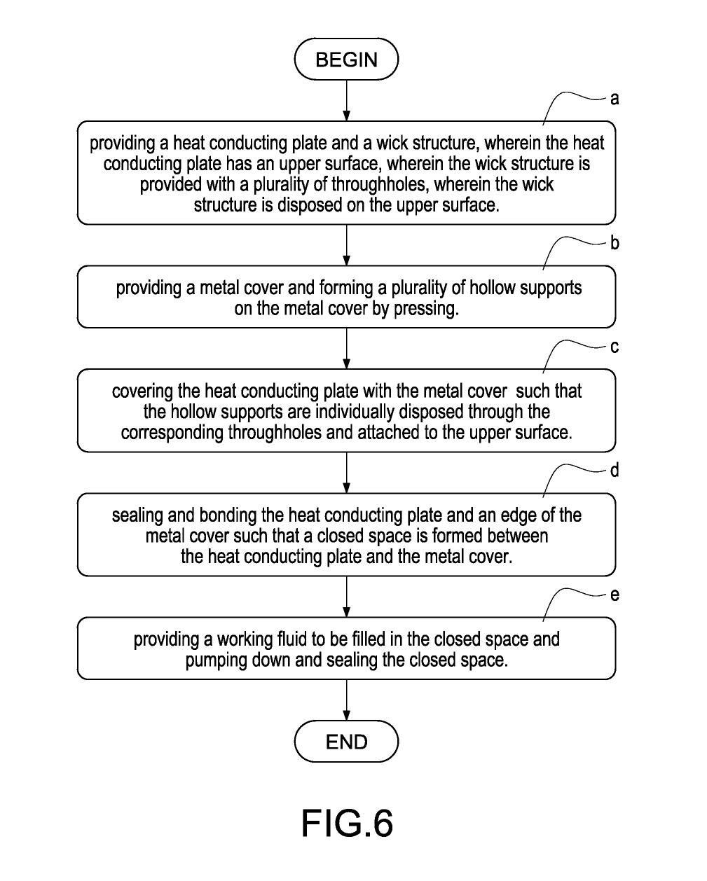

FIG. 6 is a flowchart of a manufacturing method of a thin vapor chamber 10 of the present invention. The first step, as shown in FIG. 1 and the step (a) of FIG. 6, is to provide a heat conducting plate 1 and a wick structure 3 in which the heat conducting plate 1 has an upper surface 11. The wick structure 3 is provided with a plurality of throughholes 31; the wick structure 3 is disposed on the upper surface 11.

The second step, as shown in FIG. 1 and step (b) of FIG. 6, is to provide a metal cover 2 and form a plurality of hollow supports 21 on the metal cover 2 by pressing.

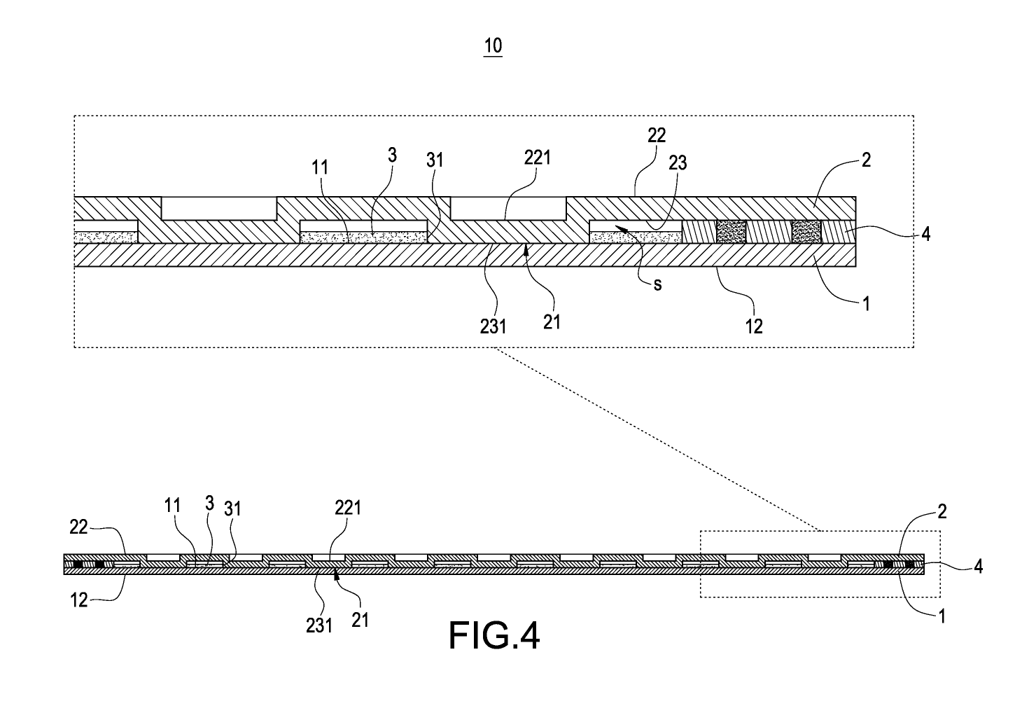

The third step, as shown in FIG. 2, FIG. 4, and step (c) of FIG. 6, is to cover the heat conducting plate 1 with the metal cover 2 such that the hollow supports 21 are individually disposed through the corresponding throughholes 31 and attached to the upper surface 11.

The fourth step, as shown in FIG. 2, FIG. 4, and step (d) of FIG. 6, is to seal and bond the heat conducting plate 1 and an edge of the metal cover 2 such that a closed space s is formed between the heat conducting plate 1 and the metal cover 2.

Besides, step (d) can further comprise the step of providing a bonding frame 4 which is disposed between the heat conducting plate 1 and the metal cover 2 to seal and bond the bonding frame 4, the heat conducting plate 1, and an edge of the metal cover 2.

The fifth step, as shown in step (e) of FIG. 6, is to provide a working fluid to be filled in the closed space s and to pump down and seal the closed space s. In this way, the thin vapor chamber 10 of the present invention is completed through the above steps (a)-(e).

In summary, the thin vapor chamber and the manufacturing method thereof of the present invention have not been anticipated by the prior art and have not been used in public. Also they are indeed novel, useful, and non-obvious to be patentable. Please examine the application carefully and grant it as a formal patent for protecting the rights of the inventor.

What is claimed is:

1. A thin vapor chamber (10), comprising:
a heat conducting plate (1) having an upper surface (11);
a metal cover (2) sealed on and covering the heat conducting plate (1), wherein a plurality of hollow supports (21) are formed on the metal cover (2) by pressing and face the heat conducting plate (1); and
a wick structure (3) disposed between the heat conducting plate (1) and the metal cover (2), wherein the wick structure (3) is provided with a plurality of throughholes (31), wherein the hollow supports (21) are individually disposed through the corresponding throughholes (31) and attached to the upper surface (11).

2. The thin vapor chamber (10) according to claim 1, wherein the metal cover (2) has a topside (22) and a bottom side (23), wherein the hollow supports (21) individually form corresponding recesses (221) facing the topside (22) and form corresponding protrusions (231) facing the bottom side (23) such that a cross section of the metal cover (2) has a zigzag shape.

3. The thin vapor chamber (10) according to claim 1, wherein the wick structure (3) is disposed on the upper surface (11).

4. The thin vapor chamber (10) according to claim 1, further comprising a working fluid filled in a closed space (s) formed by the heat conducting plate (1) and an inner part of the metal cover (2).

5. The thin vapor chamber (10) according to claim 1, further comprising a bonding frame (4) bonded between the heat conducting plate (1) and the metal cover (2).

6. The thin vapor chamber (10) according to claim 1, wherein the wick structure (3) is made of sintered particles, metal mesh, etched grooves or the combination thereof.

7. A manufacturing method of a thin vapor chamber (10), comprising the steps of:
(a) providing a heat conducting plate (1) and a wick structure (3), wherein the heat conducting plate (1) has an upper surface (11), wherein the wick structure (3) is provided with a plurality of throughholes (31), wherein the wick structure (3) is disposed on the upper surface (11);
(b) providing a metal cover (2) and forming a plurality of hollow supports (21) on the metal cover (2) by pressing;
(c) covering the heat conducting plate (1) with the metal cover (2) such that the hollow supports (21) are individually disposed through the corresponding throughholes (31) and attached to the upper surface (11);
(d) sealing and bonding the heat conducting plate (1) and an edge of the metal cover (2) such that a closed space (s) is formed between the heat conducting plate (1) and the metal cover (2); and
(e) providing a working fluid filled in the closed space (s) and pumping down and sealing the closed space (s).

8. The manufacturing method according to claim 7, wherein the metal cover (2) has a topside (22) and a bottom side (23), wherein the hollow supports (21) individually form corresponding recesses (221) facing the topside (22) and form corresponding protrusions (231) facing the bottom side (23) such that a cross section of the metal cover (2) has a zigzag shape.

9. The manufacturing method according to claim 7, wherein the step (d) further comprises the step of providing a bonding frame (4) which is disposed between the heat conducting plate (1) and the metal cover (2) to seal and bond the bonding frame (4), the heat conducting plate (1), and an edge of the metal cover (2).

10. The manufacturing method according to claim 7, wherein the wick structure (3) is made of sintered particles, metal mesh, etched grooves or the combination thereof.
